(19) United States
(12) Patent Application Publication
(10) Pub. No.: US 2025/0245277 A1
(43) Pub. Date: Jul. 31, 2025

(54) SYSTEM AND METHOD FOR ENHANCING DIGITAL INTERACTIONS THROUGH PHYSICAL CHARACTERISTIC-BASED MATCHING AND AI-DRIVEN PERSONALIZATION

(71) Applicant: Kari Sorenson Peters, San Luis Obispo, CA (US)

(72) Inventor: Kari Sorenson Peters, San Luis Obipo, CA (US)

(73) Assignee: Kari Sorenson Peters, San Luis Obispo, CA (US)

(21) Appl. No.: 19/038,922

(22) Filed: Jan. 28, 2025

Related U.S. Application Data
(60) Provisional application No. 63/626,645, filed on Jan. 30, 2024.
(60) Provisional application No. 63/650,101, filed on May 21, 2024.

(51) Int. Cl. G06F 16/9535; G06Q 30/0601; G06Q 50/00; G06T 7/60; H04L 67/306

(52) U.S. Cl. CPC G06F 16/9535; G06Q 30/0641; G06Q 50/01; G06T 7/60; H04L 67/306; G06T 2207/30196

(57) ABSTRACT

This invention relates to a system and method that enhances user interaction and marketing effectiveness through advanced data integration and personalized algorithms. The system and method collects detailed user data through body scanning and questionnaires, creating comprehensive profiles using machine learning. These profiles facilitate precise matching of influencers with businesses based on physical attributes, audience demographics, and content preferences. The system generates AI-driven marketing personas tailored to specific demographics and enables live shopping integration with social platforms. A novel double-blind review mechanism ensures transparent feedback between businesses and influencers. The platform supports group profiles that aggregate multiple users' data, enabling family-based shopping with privacy controls and preference weighting. The system continuously refines its algorithms using campaign performance data and engagement metrics, optimizing future matches and marketing strategies. This innovative approach significantly improves marketing ROI, user engagement, and personalization for digital social interaction and targeted marketing.

### CROSS-REFERENCE TO RELATED APPLICATIONS

This application claims priority to U.S. Provisional Patent Application No. 63/626,645 filed Jan. 30, 2024 and U.S. Provisional Patent Application No. 63/650,101 filed May 21, 2024, the entire contents of which are hereby incorporated by reference.

### BACKGROUND OF THE INVENTION

In the realm of digital interaction and online platforms, personalization and accurate representation of physical characteristics have become increasingly important. Traditionally, platforms have relied on user-reported data or basic photographic inputs to gather information about an individual's physical attributes. However, these methods often lack precision and do not fully capture the comprehensive physical characteristics necessary for various applications, such as personalized shopping experiences, virtual try-ons, and tailored content delivery.

Recent advancements have seen the development of technologies that utilize smartphone cameras to scan a person's body, capturing detailed measurements and other physical characteristics. These technologies often leverage API technology to facilitate the scanning process, allowing users to take pictures from different angles using their smartphones. The data captured from these scans can then be processed to extract detailed measurements and create a digital representation of the user's physique.

Despite these advancements, there remains a significant gap in the integration of this scanned data with other user-provided information and its application across different platforms. Current systems often treat body scanning as a standalone feature rather than an integrated part of a broader ecosystem that includes user preferences, lifestyle information, and social media data.

Existing platforms struggle with search functionality limitations, particularly in connecting users with products and content that match their specific physical characteristics and preferences. Moreover, the existing technologies primarily focus on the individual consumer side, with less emphasis on how these detailed physical characteristics can be utilized in influencer marketing, virtual avatar creation, and targeted advertising. Current platforms lack effective mechanisms for matching consumers with influencers based on shared physical characteristics and other important criteria for making purchasing decisions.

Existing platforms in the digital marketing and social commerce space exhibit several key limitations. Platforms like TikTok and Instagram, while dominant in content discovery and live shopping, lack effective mechanisms for helping users find specific products tailored to their needs, resulting in information overload and inefficient product discovery.

Current influencer marketing platforms such as LTK, Captivate, Affluence, and Grin struggle with precise matching between businesses and influencers, particularly in leveraging detailed physical characteristics and audience demographics for targeted marketing. These platforms also lack sophisticated data collection and analysis capabilities that could enable more effective revenue modeling and customer demographic matching. SHOPMY's approach of allowing product searches by category rather than through influencer connections fails to capitalize on the personal connection and trust that influences purchasing decisions. Additionally, existing platforms lack robust mechanisms for tracking and updating changing characteristics of both users and influencer audiences over time, making it difficult to maintain accurate matching between consumers, influencers, and businesses. The integration of physical attribute data with digital marketing platforms remains fragmented, with businesses struggling to identify relevant influencers even with fixed audience characteristics. This challenge is further complicated by the evolving nature of both user characteristics and influencer audiences over time, and the lack of mechanisms to track and respond to these changes. Furthermore, current platforms fail to provide comprehensive solutions for group shopping scenarios, particularly in cases where a primary purchaser makes decisions for multiple group members, such as family units.

Additionally, businesses face challenges in finding influencers with specific attributes needed to effectively promote their products. The integration of physical attribute data with digital marketing platforms remains fragmented, with businesses struggling to identify relevant influencers even with fixed audience characteristics. This challenge is further complicated by the evolving nature of both user characteristics and influencer audiences over time. Furthermore, existing platforms fail to provide robust mechanisms for tracking and updating these changing characteristics, making it difficult to maintain accurate matching between consumers, influencers, and businesses.

As such, there remains a need to provide a robust foundation for personalized digital interaction and marketing strategies, setting a new standard for accuracy and user engagement based upon user characteristics. This includes the need for improved systems that can effectively integrate comprehensive body scan data with advanced data analytics and machine learning techniques to create highly accurate and personalized user profiles that can enhance user experiences across various platforms.

### SUMMARY OF THE INVENTION

The present invention provides comprehensive systems and methods for enhancing digital interactions and marketing strategies through advanced body scanning technology, data analytics, and machine learning. The systems and methods described herein facilitate precise matching among consumers, influencers, and businesses based on detailed physical characteristics and preferences, while enabling novel features such as AI-driven persona generation and live shopping integration.

The initial step in the user interaction with the platform involves creating a personal profile, which is pivotal for several reasons. This process not only establishes a unique identity for each user on the platform but also serves as the foundational layer upon which further customization and personalization of services are built. The comprehensive data collection process incorporates body scanning technology, lifestyle questionnaires, and social media integration to create highly accurate user profiles that drive the platform's matching capabilities.

The platform utilizes machine learning algorithms to analyze and process the collected data, enabling the creation of detailed user profiles that can be used for various purposes, including matching consumers with relevant influencers and products, connecting businesses with suitable influencer partners, and generating AI-driven marketing personas. This sophisticated approach to data analysis and profile creation sets the foundation for the platform's ability to deliver highly personalized experiences and targeted marketing solutions.

The system's architecture is designed to support multiple user types—consumers, influencers, and businesses—each with specific features and capabilities tailored to their needs. For consumers, the platform provides personalized product recommendations and content based on their physical characteristics and preferences. For influencers, it offers tools to connect with relevant businesses and audiences. For businesses, it provides advanced matching capabilities and performance tracking tools, including a novel double-blind review system that ensures transparent and honest feedback between parties.

The platform also supports the creation of group profiles, which aggregate data from multiple individual profiles to offer tailored recommendations and services to groups such as families. This enables precise matching among consumers, influencers, and businesses based on detailed physical characteristics and preferences, while facilitating novel features such as AI-driven persona generation and live shopping integration.

Furthermore, the system employs a matching system that aligns influencers with businesses by analyzing the compatibility of their profiles, including information pertaining to physical characteristics collected via body scanning. This system assesses physical attributes, audience demographics, and content preferences to ensure effective and impactful marketing collaborations and campaigns. After such marketing collaborations and campaigns, the platform collects feedback and performance data to continuously refine and optimize the matching algorithms, thereby enhancing the accuracy and effectiveness of future matches.

### BRIEF DESCRIPTION OF THE FIGURES

FIG. 1 depicts a frontal body scan user interface in accordance with an exemplary embodiment.

FIG. 2 depicts a side body scan user interface in accordance with an exemplary embodiment.

FIG. 3 depicts a user profile user interface in accordance with an exemplary embodiment.

FIG. 4 depicts a matching dashboard user interface in accordance with an exemplary embodiment.

FIG. 5a depicts a user group user interface in accordance with an exemplary embodiment.

FIG. 5b depicts a user group matching user interface in accordance with an exemplary embodiment.

FIG. 6 depicts an influencer matching user interface in accordance with an exemplary embodiment.

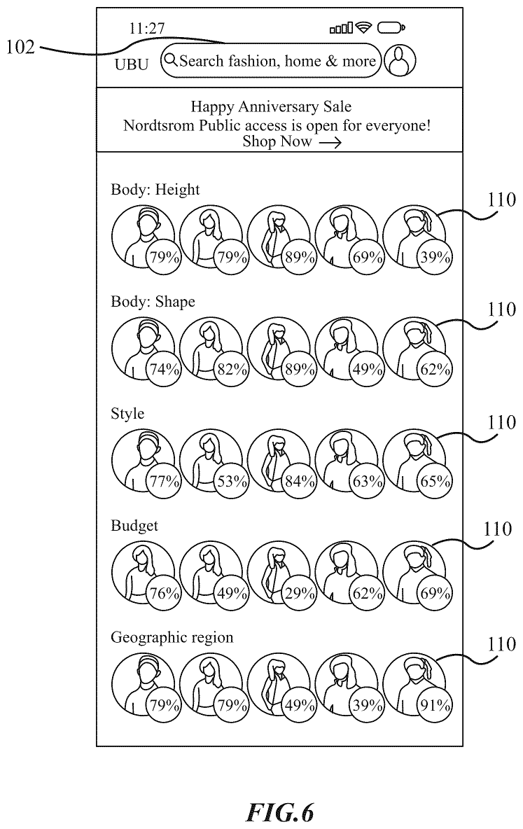

FIG. 7 depicts an advertising company user interface in accordance with an exemplary embodiment.

FIG. 8 depicts a system diagram in accordance with an exemplary embodiment.

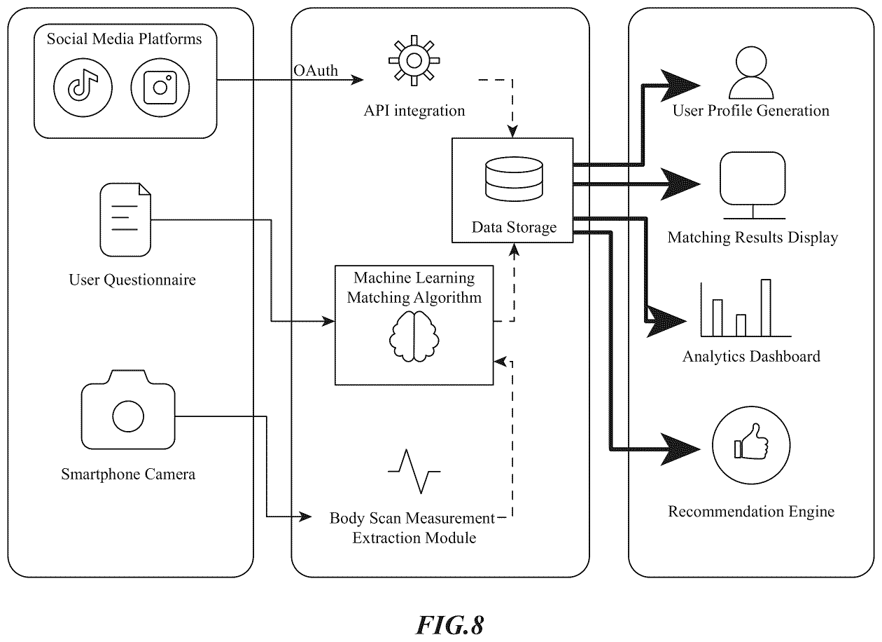

### DETAILED DESCRIPTION

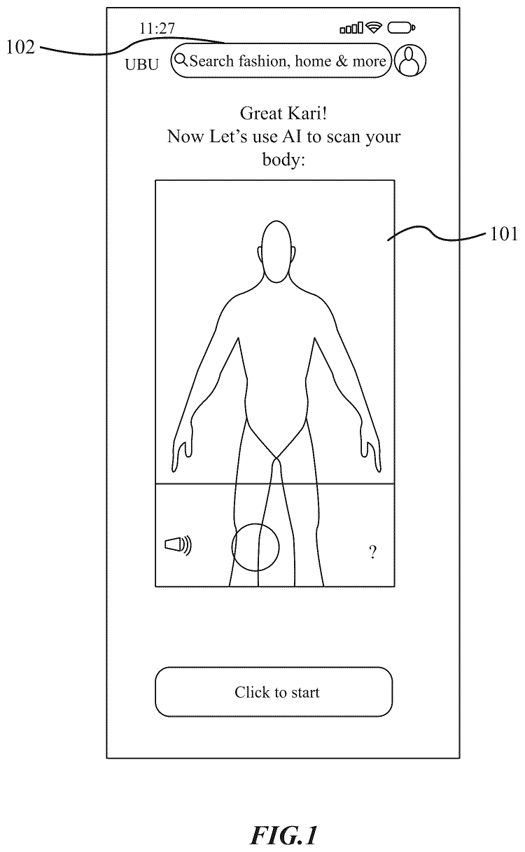

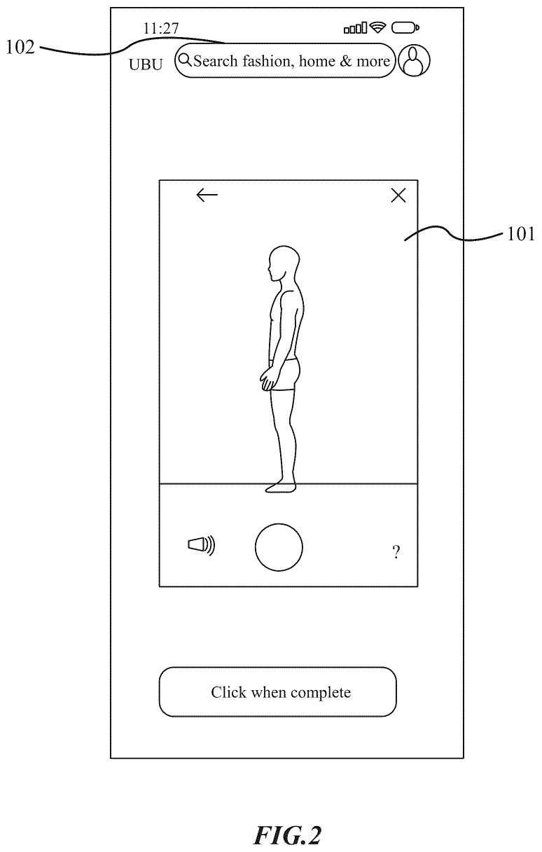

The present invention in accordance with various embodiments provides comprehensive systems and methods for enhancing digital interactions and marketing strategies through advanced body scanning technology, optionally in accordance with mobile device cameras and user interfaces such as depicted in FIGS. 1 and 2, data analytics, and machine learning. The systems and methods described herein facilitate precise matching among consumers, influencers, and businesses based on detailed physical characteristics and preferences, while enabling novel features such as AI-driven persona generation and live shopping integration.

The initial step in the user interaction with the platform involves creating a personal profile, which is pivotal for several reasons. This process not only establishes a unique identity for each user on the platform but also serves as the foundational layer upon which further customization and personalization of services are built. The comprehensive data collection process incorporates body scanning technology, lifestyle questionnaires, and social media integration 103 to create highly accurate user profiles 104 that drive the platform's matching capabilities.

The platform in various embodiments utilizes machine learning algorithms to analyze and process the collected data, enabling the creation of detailed user profiles 104 that can be used for various purposes, including matching consumers with relevant influencers and products, connecting businesses with suitable influencer partners, and generating AI-driven marketing personas. This sophisticated approach to data analysis and profile creation sets the foundation for the platform's ability to deliver highly personalized experiences and targeted marketing solutions.

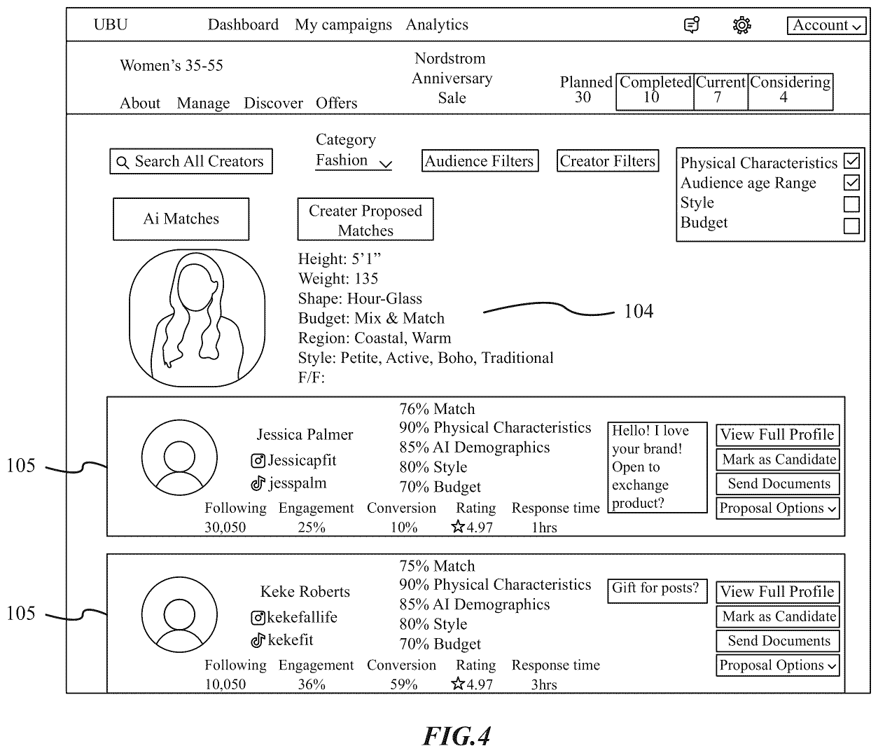

Unlike traditional platforms where users may follow influencers for entertainment or aspirational reasons, the preferred embodiment of the present invention facilitates highly targeted connections specifically oriented toward purchase intent and conversion. In accordance with various embodiments, the user may utilize a search functionality 102 to facilitate identification targeting of influencers, items, personal connections and other criteria to allow utilization of other aspects of the system. In various embodiments, the system can generate suggested connections 105 based upon matching to characteristics of the user's user profile 104, as depicted by FIG. 4. In other examples, the system facilitates the generation of suggested connections 105 that are influencers related to a company or a company's profile or products. The system's matching algorithms ensure that influencers are connected with audiences who demonstrate specific shopping interests and purchase readiness, rather than merely casual browsing or entertainment-seeking behaviors. In such embodiment, the platform's unique approach combines physical characteristic data with purchase behavior analysis to identify and connect influencers with followers who are most likely to convert into customers. This purchase-oriented matching is achieved through comprehensive analysis of user interactions, shopping patterns, and engagement metrics that indicate buying intent. The system specifically analyzes conversion rates and purchase behaviors to refine its matching algorithms, ensuring that businesses are connected with influencers whose audiences demonstrate the highest likelihood of engaging in commercial transactions. This targeted approach to audience matching represents a significant advancement over traditional platforms that focus primarily on general engagement metrics or broad demographic matching, as it enables businesses to connect with consumers who are specifically positioned and ready to make purchasing decisions. The platform's emphasis on purchase intent in its matching algorithms helps ensure that marketing resources are directed toward audiences with the highest probability of conversion, thereby improving the efficiency and effectiveness of influencer marketing campaigns.

In accordance with the preferred embodiment, a user captures two pictures of themselves, one from the side and one from the front, via use of their smartphone. The platform utilizes third-party scanning technology via API, in an embodiment specifically from a service such as Bodygram, StyleQ, or Fit3D, to process these images. The platform incorporates machine learning algorithms to analyze the images and extract precise body measurements and other relevant physical characteristics.

The body scanning process begins with the user capturing specific images of themselves, typically from the front and side. This is crucial for creating a comprehensive 3D model of the user's body. A smartphone app guides the user through the process of capturing images, providing instructions on how to position the camera and themselves, ensuring that the images are taken at the correct angles and under good lighting conditions to enhance the accuracy of the scan.

Once the images related to the body scan 101 are captured, optionally via user interfaces as depicted by FIGS. 1 and 2 in accordance with an exemplary embodiment, they are processed using algorithms to extract precise measurements and generate a digital model of the user's body. The processing of the captured images provides a comprehensive scan that includes body circumferences, volumes, and surface area, among other metrics.

The data obtained from the body scans is then integrated into the user's profile on the platform, enhancing the personalization of services. The extracted data is synchronized with the user's existing profile (or a new profile, if the user does not yet have an existing profile). This integration allows the platform to utilize physical attributes alongside other user-provided information such as lifestyle choices and preferences from the questionnaire.

The comprehensive data collected can be used in various ways, including retail applications where precise body measurements can be used to recommend clothing sizes, suggest styles that would fit well, and enable virtual try-ons. The measurements may also be utilized to connect a user with similar users or influencers exhibiting similar body measurement characteristics. For fitness and health objectives, the measurements can be particularly useful for tracking fitness progress, providing health assessments, and personalizing workout plans.

The platform allows users to update their scans periodically to reflect any changes in their physique, ensuring that the personalization remains accurate over time. Users can re-scan themselves using the same technology, and the new data is seamlessly updated in their profiles. This feature is particularly useful for fitness tracking or during significant body changes such as weight loss or pregnancy.

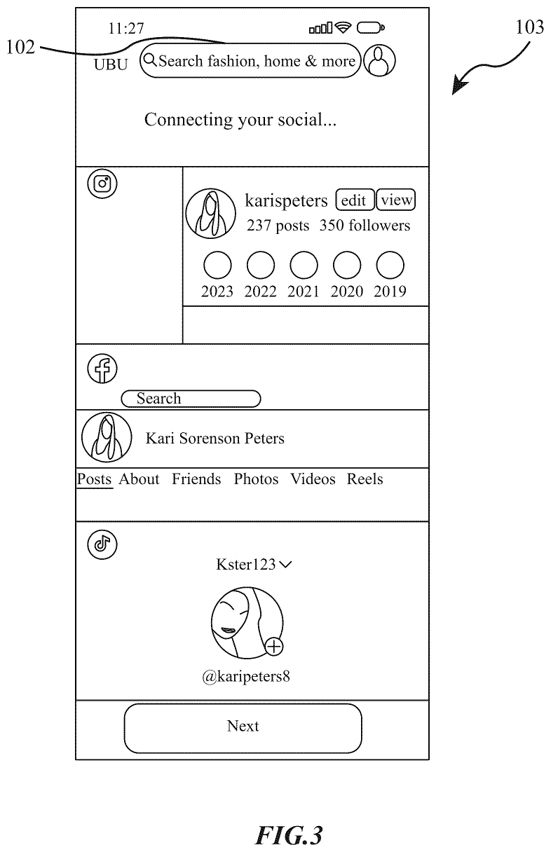

In an embodiment, users can choose to integrate their profile with their social media accounts, in an exemplary embodiment via a user interface such as that depicted by FIG. 3. This integration in an embodiment is facilitated through APIs that connect the platform with social media services. The platform utilizes OAuth protocols, a standard for access delegation commonly used as a way for internet users to grant websites or applications access to their information on other websites but without giving them the passwords. This ensures that the integration is secure and that the platform only accesses information permitted by the user.

The integration with social media 103 provides several advantages. As social media profiles often contain a wealth of information that users have already curated, such as likes, interests, and social circles, this information can be invaluable for personalization algorithms. Moreover, the incorporation of information from social media profiles provides for obtaining updated information, as social media data is generally current, reflecting the latest interests and changes in the user's life.

The system leverages both self-reported attributes and technology-driven analysis to generate robust matching criteria for each user. The AI engine enhances this with social listening, scraping key metadata from platforms like Instagram and TikTok to uncover audience gender splits, top geographies, frequently used hashtags and more.

The system also dynamically updates criteria based on social media activity over time. If a user's posts start shifting focus to different topics or interests, the engine will auto-tag them with additional categories. If they travel to new locations and geotag content there, those locations get added to geographic targeting. The system continues to monitor changing matching criteria associated with the user and their social media activities to detect similar matching criteria among users and businesses with profiles within the system.

Following the body scanning process, in accordance with an embodiment a step associated with enhancing the user's profile involves completing a lifestyle and style questionnaire. This step is important as it captures qualitative data that complements the quantitative measurements obtained from the body scan 101 in accordance with the preferred embodiment.

The questionnaire is structured to be user-friendly and engaging to promote high completion rates. In an embodiment, the questionnaire includes a mix of multiple-choice questions, sliders for preference strength, and open-ended questions to capture nuanced information. The questionnaire is designed to be dynamic, adapting questions based on previous answers to delve deeper into user preferences.

The questionnaire can be presented through various user interfaces or via voice-activated technologies to enhance accessibility and user engagement. A graphical user interface on a smartphone or computer can display the questionnaire with interactive elements such as clickable options, drag-and-drop sliders, and text boxes for open-ended responses, all designed with visual cues to guide the user seamlessly through the process. Additionally, voice-activated technologies like Siri or Alexa can be employed to administer the questionnaire audibly, allowing users to respond verbally.

The content of the questionnaire covers various aspects of the user's lifestyle and personal style preferences, including fashion preferences about preferred styles, colors, fabric types, and fit preferences. Users might be asked to choose images that best represent their style or to rate how much they prefer certain clothing attributes like tightness or length. The questionnaire includes questions about daily activities, occupation, and hobbies which influence clothing and product needs, as well as questions related to health and wellness, environmental and ethical preferences, and financial and budget attributes.

Once the questionnaire is completed, the responses are integrated with the existing data from the body scan 101 and any social media-derived information via integration with social media 103. The system analyzes responses using advanced machine learning algorithms to identify patterns, trends, and individual preferences. For multiple-choice and slider responses, statistical analysis techniques are employed to quantify preferences and correlate them with demographic and behavioral data. For open-ended responses, natural language processing is utilized to parse, understand, and extract key phrases and sentiments that provide deeper insights into user preferences and expectations.

To ensure the information remains relevant and up-to-date, periodic reviews and updates are conducted based on user feedback and emerging trends. Users may also be prompted to update their questionnaire responses periodically to reflect any significant changes in their lifestyle or preferences.

In an exemplary embodiment, the system offers the capability to develop group profiles, particularly useful for entities such as families or other collective groups. This process essentially mirrors the individual profile creation steps but extends them to accommodate multiple members within the group. Each member of the group undergoes the same procedures as individual users—such as body scanning, completing lifestyle and style questionnaires, and integrating social media data via social media integration 103 if available. The data from each member of the group is then aggregated to form a collective group profile.

This comprehensive group profile captures not only the individual characteristics and preferences of each member but also identifies commonalities and group dynamics that might not be apparent from individual profiles alone. The platform can analyze the collective data to understand shared interests, common lifestyle choices, and overall group preferences.

The group profiling enables the platform to offer tailored recommendations and services that cater to the needs of the group as a whole. For example, the system suggests products that suit the entire family, such as board games, holiday packages, or home entertainment systems that align with the collective interests and preferences. For platforms that provide content or organize activities, group profiles can be used to recommend movies, books, or local events that would appeal to all group members.

Several challenges remain to be solved in association with consumers finding and purchasing products for their family members or family-like groups. Often there is a designated primary-purchaser who makes most purchase decisions for multiple members of the group. For example, a mother often makes most of the purchases for her children and husband.

The platform provides mechanisms for such a primary-purchaser to aggregate their personal shopping preferences with groupings comprising others, such as family members, to access content from influencers relevant not only to the primary-purchaser, but to those persons in the purchaser's close family network that may additionally influence the purchaser's purchase decisions.

The creation of group profiles enhances the platform's utility by enabling a more holistic approach to service delivery and personalization, especially taking into account the physical attributes of each user as derived from steps associated with body scanning, and the interconnected preferences and needs of group members. This not only improves the user experience for individual members but also fosters a sense of inclusivity and satisfaction among the group, potentially increasing user engagement and loyalty to the platform.

The system in an exemplary embodiment generates AI character avatars by targeting the demographics of companies and the audience of companies that would appeal and have a similar target audience. The platform creates AI characters in their 40s that have specific affinities for products, taking all of those actions into account to make subsets that would work for all of the companies.

The platform in an embodiment employs machine learning algorithms to analyze and process collected data, enabling the creation of detailed user profiles 104 that can be used for generating AI-driven marketing personas. For example, the system can create personas like “Shelly” who has a specific income level relative to luxury goods pricing, or “John” who attends board meetings with defined income characteristics.

The system incorporates micro-specific matching criteria to generate these AI characters, including but not limited to physical attributes, style preferences, age, income level, interests, and other demographic or personality traits. The platform utilizes deep learning analysis of social media posts over time to calculate SHAP value outputs that inform the AI character generation process. Then, in accordance with an embodiment, the system leverages machine learning to connect each AI character with primary-purchasers who exhibit characteristics and preferences relevant to the marketing persona of the AI character and then facilitates the delivery of content associated with the AI character to the connected primary-purchasers.

The system in an exemplary embodiment generates AI characters by targeting the demographics of companies and the audience of companies that would appeal and have a similar target audience. The platform creates AI characters in their 40s that have specific affinities for products, taking all of those actions into account to make subsets that would work for all of the companies.

In an exemplary implementation, these AI characters can be managed by a “puppet master” role within the system, allowing for controlled deployment and modification of the AI personas based on evolving business needs and audience characteristics. The puppet master works at UBU and oversees the creation and management of AI characters to ensure they align with marketing objectives.

The platform in an exemplary embodiment employs machine learning algorithms to analyze and process collected data, enabling the creation of detailed AI-driven marketing personas. For example, the system can create a persona like “Shelly” who has a specific income level relative to luxury goods pricing (specifically half the cost of a Louis Vuitton bag), but would be hired by Nordstrom who has a sale of the bag. Similarly, the system can generate a persona like “John,” who has defined income characteristics of $500,000 and attends board meetings.

The system in an exemplary embodiment incorporates micro-specific matching criteria to generate these AI characters, including but not limited to physical attributes, style preferences, age, income level, interests, and other demographic or personality traits. The platform utilizes deep learning analysis of social media posts over time to calculate SHAP value outputs that inform the AI character generation process. Then, the system leverages machine learning to connect each AI character with primary-purchasers who exhibit characteristics and preferences relevant to the marketing persona of the AI character and then facilitates the delivery of content associated with the AI character to the connected primary-purchasers.

The AI engine in an exemplary embodiment enhances the character generation through social listening, scraping key metadata from platforms like Instagram and TikTok to uncover audience gender splits, top geographies, and frequently used hashtags. This data helps inform the creation of AI personas that accurately reflect target demographic characteristics.

In an exemplary implementation, these AI characters can be managed by a “puppet master” role within the system, allowing for controlled deployment and modification of the AI personas based on evolving business needs and audience characteristics by one or a plurality of admin(s) with access to the system.

Various embodiments of the system are configured to provide matching among the various users and in particular users of distinct categories that access and have profiles on the system. In an exemplary embodiment, the system leverages a random forest machine learning model for matching and relevance scoring between influencer profiles and business campaign requirements. The system is trained on historical matches to identify patterns in matching criteria priorities and weights. Input features include audience demographics, content style, previous campaign performance, influencer relevance to product vertical, geographic targeting, budget, and more. Feature weights are dynamically calibrated based on ongoing match outcomes.

The business-influencer matching module in an embodiment provides the intelligence engine powering recommendations between relevant brands and partners in the preferred embodiment. The module filters and ranks suggested profiles according to businesses' specified criteria for campaigns. Over time, the module develops an empirical understanding of what objective attributes and engagement metrics correlate to success for different campaign goals.

The business-influencer matching model applies advanced weighting tactics to optimize suggested profiles likely to achieve campaign goals. Major components include a Category Affinity Score that quantifies how closely an influencer's interests and content align to a business' product vertical based on tagged metadata and hashtag analysis, with weight adjustments reflecting changing focus over previous 6-12 months. The system also employs Audience Relevance Indexing to match follower demographics, geographies, behaviors and purchasing power to a brand's historic or target customer segments through regression analysis of aggregated sales and survey data.

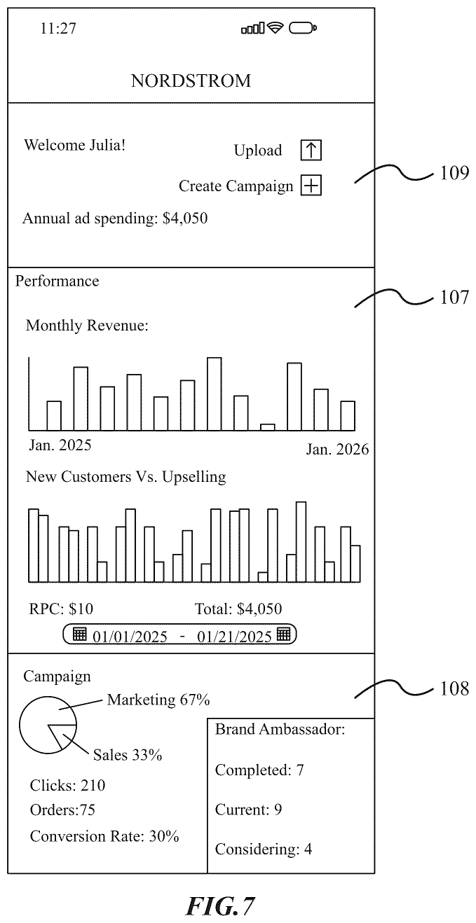

The system in an embodiment further comprises Content Performance Benchmarking, in an exemplary embodiment delivered to a user via a user interface such as that depicted by FIG. 7, to compare an influencer's engagement metrics 107. Such metrics 107 in various embodiments may comprise revenue, new customers versus upselling, click-through-rates, save ratios, and referral conversions to industry averages for different formats. In accordance with embodiments, top performers receive weighted priority in matching. Campaign Goal Optimization tunes weighting biases based on desired campaign outcomes. These core elements are calculated into an overall Match Score used for ranking candidate suggestions. In an exemplary embodiment, campaign statistics 108 may be displayed to a user on the same user interface which may depict such information as conversion, spend, and number of influencers engaged by the company.

As an influencer's audience evolves or a business launches products attracting new customer profiles, the continuous monitoring capabilities ensure recommendations stay current. The module extracts signals like new geotags, hashtag usages and audience gender splits to update an influencer's criteria. For businesses, tracking early sales or survey data tied to new offerings allows appropriate influencer targeting adjustments.

The system in an exemplary embodiment also employs machine learning algorithms to analyze text posts, captions, hashtags, images, and videos published by users to social platforms. Attribute tagging models identify concepts, styles, sentiments, named entities, visual objects, and more. User profiles 104 are enriched with these tags over time to enhance matching accuracy.

An exemplary embodiment of the invention connects and implements digital commerce via live shopping, including via API connection with external platforms such as TikTok. The platform in an exemplary embodiment comprises live shopping and facilitates the utilization of pictures and videos of products that already exist in connection with other elements of the system in connection with live shopping functionality. This integration in an embodiment thus allows for transitioning static content into live-streaming capabilities.

While TikTok at the time of filing of this application dominates live shopping, it has limitations in helping users find specific products they want. The present invention in an embodiment addresses this gap by providing enhanced matching capabilities that connect users to what they are actually looking for in a relevant way based on their body type, style or background—something TikTok isn't currently doing. The system in an embodiment thus provides a cleaner and more efficient shopping experience compared to the information overload present on platforms like TikTok and Instagram. The platform's approach centers around the concept of matching for the purpose of making the user's life more streamlined and efficient. While TikTok and Instagram provide an overwhelming amount of content, the system in an embodiment via its matching module and other aspects provides targeted, relevant matches that facilitate actual purchasing behavior. The platform of the system in an embodiment matches users on TikTok/Instagram to connect them with appropriate influencers who align with their characteristics and preferences.

The integration of live shopping capabilities in accordance with various embodiments enhances the platform's core matching functionality by allowing real-time interaction and purchasing opportunities. The present inventor has recognized that this aspect creates a more dynamic shopping experience while maintaining the system's focus on relevant, personalized matching between consumers, influencers, and products.

The platform in an exemplary embodiment provides a streamlined method for initiating contact between an interested business and influencer after their respective matching criteria aligns above a defined threshold. On the business side, when reviewing a list of suggested influencer profiles, each profile displays a visual indicator reflecting the match score percent-communicating to the business how closely the influencer matches their specified campaign criteria based on the platform's analysis.

The system in an embodiment comprises integrated tools for business to make proposals available for any influencer that reflects matching criteria desired by the business. The proposal generation module comprises document uploading and storage tools to facilitate a business supplying advertising and promotional materials pertaining to one or more specific products associated with the business to any influencer hired by the business.

Once an influencer is hired to promote a business' products, in accordance with an exemplary embodiment pixel tracking is deployed across their social content and landing pages to capture key conversion events like link clicks, email signups, content views, add-to-carts and purchases. Leveraging a business intelligence layer, the module aggregates these metrics on a dashboard showing campaign progress 108, in an exemplary embodiment as depicted by FIG. 7, against initial goals and guarantees in the contracted agreement between the business and the influencer.

In accordance with an embodiment, the data collected during the profile creation phase is crucial for the subsequent personalization processes. The platform tailors content and recommendations based on the identified characteristics of a user, inclusive of characteristics determined during the steps associated with body scanning, and the demographic and preference information provided. In such manner, the platform can deliver more relevant content, product recommendations, and services.

The system in an embodiment leverages TensorFlow machine learning models to analyze text posts, captions, hashtags, images, and videos published by users to social platforms. Attribute tagging models identify concepts, styles, sentiments, named entities, visual objects, and more. User profiles 104 are enriched with these tags over time to enhance recommendation accuracy.

Over time, the system in an embodiment refines understanding of preferences via engagement tracking. If a user shows heavy interest in certain types of content, the profile adjustments give higher visibility to like-minded influencers that feature relevant attribute tags. This empowers hyper-personalization of recommendations. The platform employs natural language processing to extract signals from social activity, surveying posts, followers, mentions and other digital footprints. Image recognition provides additional depth, tagging aesthetics, objects and scenes. This attribute bank powers a matching engine connecting users to content aligned to who they are and what they care about.

The system analyzes engagement metrics of any individual post (likes, saves, etc) to benchmark expected levels of interest. The system evaluates such metrics such that if a piece of content over-indexes, it suggests specific enthusiasm more than mass appeal, and therefore the system will deliver similar content in the future. Each of these datapoints train what resonates with users. Over months and years, the accuracy of catering recommendations improves exponentially.

For privacy protection, in accordance with an exemplary embodiment, all data inputs are user controlled. Users decide what platforms and profile aspects to connect. Robust permissions prevent external sharing without explicit approval. Insights fueling recommendations run fully on-device to limit external exposure.

The system in the preferred embodiment provides a double-blind review mechanism for business-influencer partnerships that ensures transparent and honest feedback between parties. In an exemplary embodiment, usage activity within the communication module such as response times, message frequency, and media sharing is analyzed by the system to update confidence scores on an influencer's communication level and partnership reliability. These signals refine the matching model over time.

The platform in an exemplary embodiment comprises a double-blind review system specifically for the B2B side where both the influencer and marketer must submit reviews before either party can see the other's feedback, similar to how AirBnB implements their review system. This ensures transparency and honesty in the feedback process between businesses and influencers.

The system in an embodiment collects feedback and performance data following the conclusion of marketing campaigns. This includes gathering subjective assessments from both businesses and influencers regarding the campaign's success, ease of collaboration, and perceived impact of the influencer's endorsements. Additionally, objective performance data such as engagement metrics, conversion rates, and reach statistics are collected. In an exemplary embodiment, this performance data may comprise campaign statistics 108, which may depict such information as conversion, spend, and number of influencers engaged by the company.

The collected feedback and performance data are subsequently analyzed to assess the effectiveness of the influencer-business pairing and overall campaign strategy. The insights gained from this analysis are crucial for identifying strengths and pinpointing areas that require improvement. For instance, if a campaign achieved high engagement but low conversion rates, the platform might investigate whether the influencer's audience was fully aligned with the business's target market.

The feedback and performance data are then used to refine the matching module and associated algorithms. Adjustments may be made to enhance the accuracy of matching influencers with businesses based on updated criteria such as improved demographic alignment, content style compatibility, or past campaign performance. This optimization process is iterative, with each cycle of feedback contributing to the algorithms' learning, making them smarter and more precise.

In accordance with an embodiment of the system, when proposing an influencer marketing campaign, a business manager or other business user is provided with the capability to create a structured proposal record that includes target customer personas, product info, geographic targeting, pricing tiers, desired content style, campaign goals & KPIs, and budget. This proposal data is stored for sharing with matched profiles.

The platform provides a centralized dashboard displaying asset delivery status, engagement analytics and payment tracking. This creates transparency on progress towards contractual obligations for the partnership. Both parties can message directly through the dashboard if issues emerge needing resolution.

The system provides integrated tools for business to make proposals available for any influencer that reflects matching criteria desired by the business, such as via a “create campaign” functionality and dashboard 109 as depicted in an exemplary user interface by FIG. 7. The proposal generation module further comprises document uploading and storage tools to facilitate a business supplying advertising and promotional materials pertaining to one or more specific products associated with the business to any influencer hired by the business.

The system architecture in an embodiment is designed to provide highly scalable and efficient data processing capabilities to support the platform's sophisticated matching and analysis functions. The storage module's hybrid approach balances structure, performance and scalability—essential characteristics for storing and harnessing influencer data to drive the platform at scale. This scalable infrastructure enables businesses to efficiently connect with relevant audiences through data-driven matching, regardless of the volume of users, influencers, or interactions. The platform's distributed network of servers efficiently processes large volumes of influencer and user data used in powering the matching and recommendation algorithms. The system's cloud-based approach and hybrid database model ensure that as more users, data points, and interactions are added to the platform, the matching capabilities and personalization features continue to function optimally without degradation in performance. This scalable architecture differentiates the platform from existing solutions by enabling businesses to leverage comprehensive physical characteristic data, preference information, and engagement metrics at scale to identify and connect with highly relevant audiences through targeted influencer partnerships.

The platform in an exemplary embodiment enables quantifiable performance tracking of influencer marketing campaigns. Once an influencer is hired to promote a business' products, pixel tracking is deployed across their social content and landing pages to capture key conversion events like link clicks, email signups, content views, add-to-carts and purchases. Leveraging a business intelligence layer, the module aggregates these metrics on a dashboard showing campaign progress, which may comprise campaign statistics 108 such as depicted in an exemplary user interface embodiment as depicted by FIG. 7, against initial goals and guarantees in the contracted agreement between the business and the influencer. Trend charts visualize peaks and valleys, highlighting top performing posts.

The analysis extends beyond campaign wrap to fuel a recommendation engine on the likelihood an influencer can drive results across different verticals. Over cycles, aggregate benchmarking allows the engine to serve each business tailored suggestions on their ideal influencer mix based on historical data. Ongoing optimization is fueled by A/B testing content variations, quantifying the impact of factors like call-to-actions, discounts, and visual styles on conversions.

The promotional activity analysis module thus in an embodiment of the system enables quantifiable performance tracking of influencer marketing campaigns. Once an influencer is hired to promote a business' products, pixel tracking is deployed across their social content and landing pages to capture key conversion events like link clicks, email signups, content views, add-to-carts and purchases.

Leveraging a business intelligence layer, the module aggregates these metrics on a dashboard showing campaign progress against initial goals and guarantees in the contracted agreement between and among the business and the influencer. Trend charts visualize peaks and valleys, highlighting top performing posts.

The analysis extends beyond campaign wrap to calibrate a recommendation engine on the likelihood an influencer can drive results across different verticals. For example, if a fashion retailer business sees a 3×higher conversion rate than an electronics brand from the same influencer, this performance delta gets logged.

Over cycles, aggregate benchmarking allows the engine to serve each business tailored suggestions on their ideal influencer mix based on historical data. Rather than basing this solely on subjective criteria like follower count, the empirical approach lets the platform guide budgets to partners with the highest statistical probability of reaching key performance indicators (KPIs), optionally as input into the system by an admin or a business user.

The system in an embodiment implements a comprehensive feedback loop to continuously optimize and refine its matching algorithms and recommendations over time. As users interact with the platform, respond to questionnaires, and make purchases, these interactions generate valuable data that feeds into the machine learning algorithms. The algorithms analyze this data to identify patterns and trends in user behavior and preferences. Over time, as more data is accumulated, the models become increasingly sophisticated and accurate in their predictions and recommendations. This continuous learning process allows the platform to dynamically adjust its recommendations based on real-time feedback and purchase history. In an exemplary embodiment, the step of performing a body scan 101 and the steps related to collecting data from a body scan 101 and utilizing data from a body scan 101 are repeated in accordance with this engaging in continuous learning step. The result is a perpetually improving system where personalization becomes more precise and tailored to individual users, ensuring that the content, products, and services offered are always relevant and appealing to each user. This adaptive approach not only enhances user satisfaction but also drives engagement and loyalty by consistently meeting or exceeding user expectations. In various aspects of embodiments, to ensure the information associated with the user profile 104 remains relevant and up-to-date, periodic reviews and updates are conducted based on user feedback and emerging trends. Users may also be prompted to update their questionnaire responses periodically to reflect any significant changes in their lifestyle or preferences.

Ongoing optimization in an embodiment is fueled by A/B testing content variations of the influencers post, quantifying the impact of factors like call-to-actions, discounts, and visual styles on conversions. This allows the system to give prescriptive advice to both businesses and influencers on crafting the most effective partnerships.

The system in an exemplary embodiment tracks clicks, adds items to digital carts, and logs purchase conversions collected collectively among groups of users. In this way, the benefit of the commercial activity resulting from a grouping of users may be tracked to an influencer by the system, to facilitate a metric of commercial effectiveness of the influencer and to further influencer-business engagements.

While social media platforms such as Instagram and TikTok currently dominates content discovery, it has limitations in helping users find specific products they want. The platform in the preferred embodiment addresses this gap by providing enhanced matching capabilities that connect users to what they are actually looking for in a relevant way based on their body type, style or background. The system aims to provide a cleaner and more efficient shopping experience compared to the information overload present on platforms like TikTok and Instagram.

The platform in an embodiment utilizes data collected from body scans 101, questionnaires, and social media integration 103 to enhance product discovery. By understanding the unique characteristics and preferences of each user, the platform can tailor its interactions, ensuring that all recommendations, whether they are product suggestions, content, or services, are highly relevant and personalized to individual needs.

The system in an embodiment leverages machine learning algorithms to analyze text posts, captions, hashtags, images, and videos to identify concepts, styles, sentiments, and visual objects. These attribute tagging models enrich user profiles 104 over time, enabling more accurate product recommendations. Natural language processing extracts signals from social activity, while image recognition provides additional depth by tagging aesthetics, objects, and scenes.

The platform in an exemplary embodiment specifically delivers to users relevant content generated by influencers as determined by the detected and weighted matching criteria. To aid the tracking of commercial effectiveness, the system tracks clicks, adds items to digital carts, and logs purchase conversions. This data is then used to continuously refine and improve product discovery and recommendations.

When providing product recommendations, the system in an embodiment specifically considers physical measurements and personal preferences of a consumer user or a member of the consumer user's grouping of users in the system to suggest items that not only fit perfectly but also align with the user's style and functional needs. For instance, in a fashion retail context, the system suggests clothing items that match the user's body dimensions while also reflecting their preferred style, such as casual, formal, or sporty.

The platform in an embodiment enables users of various categories on the system to integrate their profiles with social media accounts 103 through secure API connections that utilize OAuth protocols for access delegation. This integration allows the system to collect and analyze data across multiple platforms while maintaining user privacy and security.

The system in an embodiment leverages both self-reported attributes and technology-driven analysis, employing AI engines to enhance profiles through social listening and metadata scraping from platforms like Instagram and TikTok. This cross-platform analysis uncovers key information such as audience demographics, geographic distributions, and content preferences.

The platform in an embodiment continuously monitors and updates user criteria based on social media activity across different platforms. When users' posts shift focus or demonstrate new interests, the system automatically updates their profile attributes. For example, if a user begins posting content in new locations or engaging with different types of content, these changes are reflected in their profile for improved matching and recommendations.

For businesses and influencers, in an embodiment the system provides integrated tools for managing content across multiple platforms. The platform deploys pixel tracking across social content and landing pages to capture conversion events and engagement metrics, aggregating this data into comprehensive performance analytics that span multiple platforms.

The system in an embodiment analyzes engagement metrics across platforms to benchmark expected levels of interest and performance. This cross-platform analysis helps identify content that resonates particularly well with specific audiences, enabling more precise targeting and content optimization across different social media channels.

The platform in an embodiment enables matching consumers to products across all product lines by measurement. A user, especially a user of the consumer category or influencer category, can input their measurements and query which products would fit specific body parts, such as arms, across all available brands. The system maintains consumer measurements and utilizes this data to match consumers directly to products.

The data collected from body scans 101, especially associated with consumer users and influencer users, in accordance with an embodiment can be used in retail applications where precise body measurements enable recommendation of clothing sizes, suggestion of styles that would fit well, and virtual try-ons. The measurements collected through body scanning can be particularly useful for matching users with products tailored to their physical specifications.

In an exemplary embodiment, the present invention provides a comprehensive ecosystem that fundamentally transforms how physical characteristics and digital marketing interact, rather than treating body scanning as an isolated feature. By integrating advanced body scanning technology with sophisticated data analytics, machine learning algorithms, and social platform connectivity, the system creates an interconnected environment where physical attributes directly inform and enhance digital interactions. This integrated approach facilitates precise matching between consumers, influencers, and businesses based on comprehensive physical and behavioral data, setting a new standard for personalization in digital marketing. The platform's holistic architecture ensures that body measurements and physical characteristics serve as foundational elements that influence every aspect of the user experience, from product recommendations to influencer matching and marketing campaign optimization. This ecosystem approach represents a significant advancement over existing platforms that treat physical attributes and digital engagement as separate domains, enabling the platform to redefine how businesses connect with consumers through data-driven, physically-informed digital interactions. The system's comprehensive integration of physical characteristics with digital marketing capabilities creates an environment where all components work in concert to deliver highly personalized and effective marketing solutions.

The system in an embodiment processes captured images using algorithms to extract precise measurements and generate a digital model of the user's body. This comprehensive scan includes body circumferences, volumes, and surface area metrics, which are then used to match users with appropriate products. The extracted data synchronizes with the user's profile, allowing the platform to utilize physical attributes alongside other user-provided information to enhance product matching.

For detailed analysis of fit and body shape, the measurements collected from body scanning can be specifically useful for matching users with products like custom furniture or ergonomic items tailored to the user's physical specifications. The system can analyze posture and body shape data to provide precise product recommendations.

The platform continuously updates these measurement-based matches as users update their scans to reflect physical changes. This ensures that product recommendations remain accurate over time, particularly during significant body changes such as weight fluctuation or pregnancy. The system seamlessly updates the user's profile with new measurements to maintain accurate product matching.

The system in an embodiment leverages machine learning, optionally leveraging TensorFlow machine learning models, to analyze text posts, captions, hashtags, images, and videos published by users to social platforms in real-time. Attribute tagging models identify concepts, styles, sentiments, named entities, visual objects, and other categories. User profiles 104 are enriched with these tags over time to enhance the accuracy of content filtering and categorization in accordance with an embodiment.

The platform in an embodiment employs natural language processing to extract signals from social activity, surveying posts, followers, mentions and other digital footprints. Image recognition provides additional depth, tagging aesthetics, objects and scenes. This attribute bank powers a matching engine connecting users to content aligned to who they are and what they care about.

The system dynamically updates criteria based on social media activity over time. If posts start shifting focus to different topics or interests, the engine will auto-tag them with additional categories. If users travel to new locations and geotag content there, those locations get added to geographic targeting. The system continues to monitor changing matching criteria associated with the user and their social media activities to detect similar matching criteria among users and businesses with profiles within the system.

The platform in an embodiment analyzes engagement metrics of any individual post to benchmark expected levels of interest. If a piece of content over-indexes, it suggests specific enthusiasm more than mass appeal, and therefore the system will deliver similar content in the future. Each of these datapoints train what resonates with users. Over months and years, the accuracy of content filtering and categorization improves exponentially.

The system in an embodiment offers the capability to develop group profiles, particularly useful for entities such as families or other collective groups. This process mirrors the individual profile creation steps but extends them to accommodate multiple members within the group. Each member of the group undergoes the same procedures as individual users—such as body scanning, completing lifestyle and style questionnaires, and integrating social media data 103 if available. The data from each member of the group is then aggregated to form a collective group profile.

When signing up as a new user, the system in an embodiment provides the option to link to a household or circle if profiles already exist. To request joining, the user enters an email or name associated with the current group profile. Group administrators then receive notifications to approve or deny the connection. If approved, the user inherits the aggregated attributes and preferences associated with the collective profile.

To setup a new shared profile, a consumer user in an embodiment serves as primary administrator of a group, such as a parent within a family group, first registers with an email, name and password. During onboarding, in accordance with an exemplary embodiment, such user indicates intent to create a “family” or “friend group” profile for collective matching. The administrator then completes their own onboarding survey across many attributes including demographics, interests, values and more. After their individual profiling, they use tools to send invites to join the group, specifying first name and email address for members to add.

In an embodiment, there is a designated primary-purchaser, optionally the primary administrator of a group, who makes most purchase decisions for multiple members of the group. The platform provides mechanisms for such a primary-purchaser to aggregate their personal shopping preferences with groupings comprising others, such as family members, to access content from influencers relevant not only to the primary-purchaser, but to those persons in the purchaser's close family network that may additionally influence the purchaser's purchase decisions.

The platform in an embodiment analyzes the collective data to understand shared interests, common lifestyle choices, and overall group preferences. For example, the system suggests products that suit the entire family, such as board games, holiday packages, or home entertainment systems that align with the collective interests and preferences. For platforms that provide content or organize activities, group profiles can be used to recommend movies, books, or local events that would appeal to all group members.

When matching influencers to a group member, in accordance with an embodiment the system compares attributes at both the individual and collective levels. Preference weighting determines the prioritization between group vs personal traits. The system applies formulas to balance group and individual priorities in terms of the content delivered to each user of the group. Weights may be calculated using proportional multipliers based on the relative strength of attributes in each profile area.

The creation of group profiles in an embodiment enhances the platform's utility by enabling a more holistic approach to service delivery and personalization, especially taking into account the physical attributes of each user as derived from steps associated with body scanning, and the interconnected preferences and needs of group members. This not only improves the user experience for individual members but also fosters a sense of inclusivity and satisfaction among the group, potentially increasing user engagement and loyalty to the platform.

The comprehensive group profile in an embodiment captures not only the individual characteristics and preferences of each member but also identifies commonalities and group dynamics that might not be apparent from individual profiles alone. The platform analyzes the collective data to understand shared interests, common lifestyle choices, and overall group preferences.

When matching influencers to a group member in an embodiment, the system compares attributes at both the individual and collective levels. Preference weighting determines the prioritization between group vs personal traits. The system applies formulas to balance group and individual priorities in terms of the content delivered to each user of the group. Weights may be calculated using proportional multipliers based on the relative strength of attributes in each profile area.

If an interest ranks highly on both profiles, in accordance with an exemplary embodiment an even 1:1 weighting is attributed to determine which influencer content to display to the user. If there is divergence, proportional multipliers skew the weights towards the higher score to choose which influencer content to deliver. Vector similarity algorithms analyze the direction and magnitude differences across many attributes to determine which influencer content to display to each group member.

The system in an embodimet also applies negative weights in an embodiment. These downrank specific interests or values where opposing social activity by the individual consumer user or by consumer users within a common grouping is detected. For example, if the system detects heavy posting of political content not aligned with a group's general ideology, negative multipliers can reduce exposure to further partisan material.

In addition to evaluating positive and negative preferences, adaptive machine learning models in an embodiment examine past content engagement among the individual consumer user and the grouping. If a user and a grouping is determined via machine learning to continually engage with certain categories that are related to one another, the weighting allocated to content delivered to the individual user increases in association with those areas automatically over time, thereby increasing the prevalence of such content.

The group profiling enables the platform to offer tailored recommendations and services that cater to the needs of the group as a whole. For example, the system suggests products that suit the entire family, such as board games, holiday packages, or home entertainment systems that align with the collective interests and preferences. For platforms that provide content or organize activities, group profiles can be used to recommend movies, books, or local events that would appeal to all group members.

The platform in an embodiment analyzes the collective data to understand shared interests, common lifestyle choices, and overall group preferences. To obtain data pertaining to user attributes from and better integrate with services such as streaming platforms or subscription services, the group profile can help in suggesting suitable family or group products from derived preferences that provide the best value and enjoyment for all members.

When matching influencers to a group member, the system in an embodiment compares attributes at both the individual and collective levels. Preference weighting determines the prioritization between group vs personal traits. The system applies formulas to balance group and individual priorities in terms of the content delivered to each user of the group. Weights may be calculated using proportional multipliers based on the relative strength of attributes in each profile area.

The platform in an embodiment specifically delivers to the group and each of its users relevant content generated by influencers as determined by the detected and weighted matching criteria. To aid the tracking of the commercial effectiveness of the content delivered, the system tracks clicks, adds items to digital carts, and logs purchase conversions collected collectively among a group of users. In such way, the benefit of the commercial activity resulting from a grouping of users may be tracked to an influencer by the system, to facilitate a metric of commercial effectiveness of the influencer and to further influencer-business engagements.

Over time, as more data is accumulated through group interactions and purchases, in accordance with an embodiment the models become increasingly sophisticated and accurate in their predictions and recommendations. This continuous learning process allows the platform to dynamically adjust its recommendations based on real-time feedback and purchase history. The result is a perpetually improving system where personalization becomes more precise and tailored to individual users and groups, ensuring that the content, products, and services offered are always relevant and appealing.

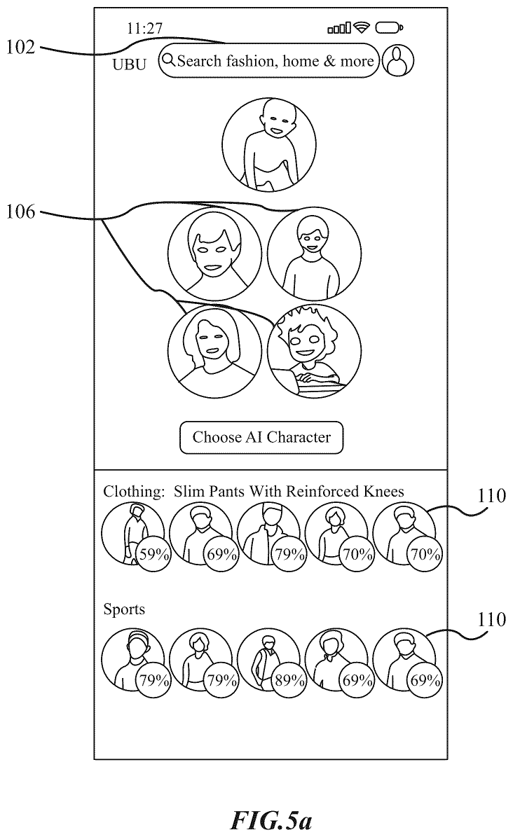

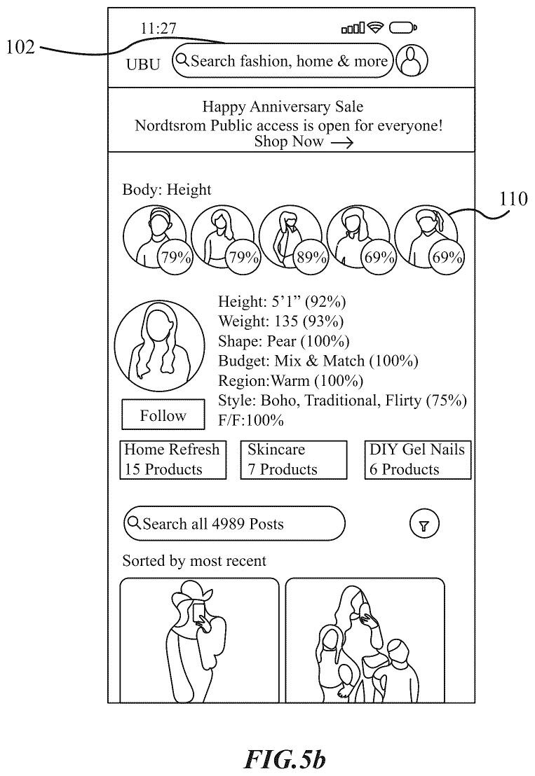

For privacy protection in content filtering and data collection, in accordance with an embodiment all data inputs are user controlled. Users decide what platforms and profile aspects to connect. Robust permissions prevent external sharing without explicit approval. Insights fueling recommendations run fully on-device to limit external exposure. The platform in an exemplary embodiment provides an option for a user that manages a group to replace the avatar of a group member user, in an example a child, with a fictional avatar 106 to conceal the actual identifying physical characteristics of the group member user, optionally via the use of a “choose AI avatar” user interface functionality as depicted by FIG. 5a.

The system in an exemplary embodiment utilizes OAuth protocols, a standard for access delegation commonly used as a way for internet users to grant websites or applications access to their information on other websites but without giving them the passwords. This ensures that the integration is secure and that the platform only accesses information permitted by the user.

Group administrators in an embodiment receive notifications to approve or deny connection requests from new members. If approved, the user inherits the aggregated attributes and preferences associated with the collective profile. The primary administrator confirms connections, and after administrator approval, group participation locks in for matching.

In an exemplary implementation, only a subset of consumer users within the group may see messages or influencer content relevant to the preferences of the entirety of the group. This allows for controlled access to group-wide content and recommendations based on administrator settings.

The system in an embodiment applies negative weights to suppress certain content from being shown to group members. For example, if the system detects content not aligned with a group's general preferences or values, negative multipliers can reduce exposure to such material. Group administrators can manually increase or remove these negatives for a member if desired in accordance with an embodiment.

The terms “system” and “platform” are used interchangeably throughout the invention to describe the comprehensive technological infrastructure that enables the various functionalities described in accordance with various embodiments. The system/platform comprises both the underlying technical components (such as the machine learning algorithms, APIs, and data processing capabilities) and the user-facing interfaces through which users interact with these components.

For example, when describing the body scanning functionality, it is referred to as both a “system” that “incorporates machine learning algorithms to analyze the images” and a “platform” that “allows users to update their scans periodically.” Similarly, when discussing the business-influencer interaction capabilities, it is characterized as both a “system” that “provides a double-blind review mechanism” and a “platform” that “enables quantifiable performance tracking.” This interchangeable usage reflects that the invention represents both the technical infrastructure (system) and the service delivery mechanism (platform) through which users access and utilize the technological capabilities.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

I claim:

1. A system for enhancing digital interactions and marketing strategies, comprising:
a processing system configured to:
receive body scan data from a plurality of users captured via smartphone cameras;
extract physical measurements from the body scan data using machine learning algorithms;
create user profiles incorporating the physical measurements and additional user data;
match users with relevant content based on the physical measurements and user data;
generate AI marketing personas based on demographic and physical characteristic data;
facilitate live shopping interactions between matched users.

2. The system of claim 1, wherein the processing system is further configured to:
implement a double-blind review mechanism between businesses and influencers;
track performance metrics of marketing campaigns;
refine matching algorithms based on collected performance data.

3. The system of claim 1, wherein generating AI marketing personas comprises:
creating AI characters with specific income characteristics;
managing AI character deployment through a puppet master role;
matching AI characters to primary purchasers based on shared characteristics.

4. A method for facilitating digital marketing interactions, comprising:
receiving body scan images from a user's smartphone;
processing the images to extract physical measurements;
creating a user profile incorporating the measurements;
matching the user with relevant content based on the profile;
facilitating commercial transactions based on the matches.

5. A system for managing group profiles, comprising:
a processing system configured to:
receive individual user profiles including body scan data;
aggregate multiple individual profiles into a group profile;
analyze collective data to identify shared preferences;
provide group-based recommendations;
implement privacy controls for group members.

6. The system of claim 5, wherein the processing system is further configured to:
weight individual versus group preferences;
apply negative weights to suppress non-aligned content;
track group-wide commercial activity.

7. The system of claim 5, wherein the processing system is further configured to:
designate a primary purchaser for the group;
aggregate shopping preferences of group members;
deliver targeted content based on collective preferences.

8. A method for managing group profiles, comprising:
receiving individual user profiles including body scan data;
aggregating multiple profiles into a group profile;
analyzing collective data for shared preferences;
implementing administrator controls for group access;
providing privacy protections for group members.

9. The method of claim 8, further comprising:
calculating preference weights between individual and group attributes;
delivering personalized content based on weighted preferences;
tracking group-wide engagement metrics.

10. The method of claim 8, further comprising:
replacing actual physical characteristics with fictional avatars for selected group members;
controlling access to group-wide content;
managing connection requests through administrator approval.

11. The system of claim 1, wherein the processing system is further configured to:
receive individual user profiles including body scan data;
aggregate multiple individual profiles into a group profile;
analyze collective data to identify shared interests and preferences;
implement administrator controls for group access.

12. The system of claim 11, wherein analyzing collective data comprises:
calculating preference weights between individual and group attributes;
applying proportional multipliers based on attribute strength;
adjusting weights based on engagement metrics.

13. The system of claim 11, wherein the processing system is further configured to:
deliver personalized content to group members based on weighted preferences;
track group-wide engagement metrics;
refine recommendations based on collective interaction data.

14. The system of claim 11, wherein implementing administrator controls comprises:
replacing physical characteristics with fictional avatars for selected members;
controlling access to group-wide content;
managing connection requests through administrator approval.

15. The system of claim 11, wherein the processing system is further configured to:
designate a primary purchaser for the group;
aggregate shopping preferences of group members;
track commercial activity across the group.

16. The system of claim 11, wherein analyzing collective data comprises:
applying negative weights to suppress non-aligned content;
monitoring social media activity across group members;
updating group preferences based on detected changes.

17. The system of claim 11, wherein the processing system is further configured to:
integrate with external platforms via secure API connections;
maintain privacy controls for shared data;
implement OAuth protocols for data access delegation.
